(19) United States
(12) Patent Application Publication
(10) Pub. No.: US 2005/0076374 A1
(43) Pub. Date: Apr. 7, 2005

(54) Data transmission apparatus and power supply control method for use in the same

(75) Inventor: Masao Nakamura, Akishima-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/878,349

(22) Filed: Jun. 29, 2004

(30) Foreign Application Priority Data
Aug. 27, 2003 (JP) 2003.303114

(51) Int. Cl. H04N 7/18; H04H 9/00; H04N 7/16

(52) U.S. Cl. 725/81; 725/74; 725/78; 725/80

(57) ABSTRACT

A data transmission apparatus includes a power supply unit that outputs a first power, a second power and a third power, a communication unit that is driven by the first power and executes data transmission between an external network and a local network to which a plurality of terminals are connected, a first receiving unit that is driven by the second power and receives broadcast data in response to a broadcast data reception request from each of the terminals, a second receiving unit that is driven by the third power and receives content data from an external device in response to a content data reception request from each of the terminals, and a unit configured to control the power supply unit based on states of use of the first and second receiving units to individually power on/off the first and second receiving units while the communication unit is powered on.

### CROSS-REFERENCE TO RELATED APPLICATIONS

This application is based upon and claims the benefit of priority from prior Japanese Patent Application No. 2003-303114, filed Aug. 27, 2003, the entire contents of which are incorporated herein by reference.

### BACKGROUND OF THE INVENTION

1. Field of the Invention

The present invention relates generally to a data transmission apparatus such as a home server, and more particularly to a data transmission apparatus having a function of receiving broadcast data such as a TV broadcast program data in response to a request from a terminal, and a power supply control method for use in the apparatus.

2. Description of the Related Art

In recent years, information processing technology and networking technology have developed remarkably. With this development, a home network system has been developed for connecting household electronic apparatuses such as a TV and audio equipment.

In the home network system, a home server is connected over a network to a client terminal such as a personal computer. Recently, a home server with a router function for connecting a local network, to which the client terminal is connected, and an external network such as the Internet, has been developed. The client terminal can communicate via the home server with some other client terminal within the home and a Web server on the Internet.

Further, a home server with a TV function for receiving broadcast data such as TV broadcast program data has been developed. The home server can output received broadcast data to an external TV receiver, and can also transmit the received broadcast data to the client terminal over the local network.

As regards the conventional home server, however, during the power-on time of the home server, power is always supplied to both a router unit and a broadcast program data receiving unit. While only the router function of the home server is being used, power is wastefully consumed by the supply of power to the broadcast program data receiving unit.

Moreover, there is a demand in these days that the home server should have not only the function of receiving broadcast data such as TV broadcast program data, but also an external input function for receiving various content data from an external device.

Jpn. Pat. Appln. KOKAI Publication No. 10-108115 discloses a method of turning off power to a non-used one of a plurality of TV tuners (a terrestrial tuner and a broadcasting satellite [BS] tuner). In this method, in accordance with the user's operation of a key switch or a remote control unit, a TV tuner, whose output is to be used, is explicitly designated. Power to the designated TV tuner is turned on.

However, the above method presupposes that a dedicated video apparatus is used in a single-user environment. No consideration is given to a multi-user environment in which a plurality of users individually control the TV function and external input function of the home server from their own client terminals. In the case of a home server that can communicate with a plurality of client terminals, it is necessary to realize a scheme for using the communication function, TV function and external input function from a plurality of terminals, without causing wasteful power consumption.

### BRIEF SUMMARY OF THE INVENTION

According to an embodiment of the present invention, there is provided a data transmission apparatus for receiving data in accordance with a request from each of a plurality of terminals, the apparatus being connected to an external device, comprising: a power supply unit that outputs a first power, a second power and a third power; a communication unit that is driven by the first power and executes data transmission between an external network and a local network to which the plurality of terminals are connected; a first receiving unit that is driven by the second power and receives broadcast data in response to a broadcast data reception request from each of the terminals, the broadcast data reception request being received by the communication unit; a second receiving unit that is driven by the third power and receives content data from the external device in response to a content data reception request from each of the terminals, the content data reception request being received by the communication unit; and a power supply control unit configured to control the power supply unit based on states of use of the first receiving unit and the second receiving unit to individually power on/off the first receiving unit and the second receiving unit while the communication unit is powered on.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the configuration of a home network system using a wireless AV station according to an embodiment of the present invention;

FIG. 2 is a block diagram showing the configuration of the wireless AV station shown in FIG. 1;

FIG. 3 is a block diagram showing an example of a power supply system that is provided in the wireless AV station shown in FIG. 1;

FIG. 4 shows an example of an AV path assignment table that is used in the wireless AV station shown in FIG. 1;

FIG. 5 illustrates a transition of the power-supply state of the wireless AV station shown in FIG. 1 in accordance with a TV viewing/listening request and a TV viewing/listening end request;

FIG. 6 illustrates a transition of the power-supply state of the wireless AV station shown in FIG. 1 in accordance with an AV content viewing/listening request and an AV content viewing/listening end request;

FIG. 7 is a flowchart illustrating a part of the procedure of a power-on sequence control process that is executed by the wireless AV station shown in FIG. 1;

FIG. 8 is a flowchart illustrating the other part of the procedure of the power-on sequence control process that is executed by the wireless AV station shown in FIG. 1;

FIG. 9 is a flowchart illustrating a part of the procedure of a power-off sequence control process that is executed by the wireless AV station shown in FIG. 1; and

FIG. 10 is a flowchart illustrating the other part of the procedure of the power-off sequence control process that is executed by the wireless AV station shown in FIG. 1.

### DETAILED DESCRIPTION OF THE INVENTION

An embodiment of the present invention will now be described with reference to the accompanying drawings.

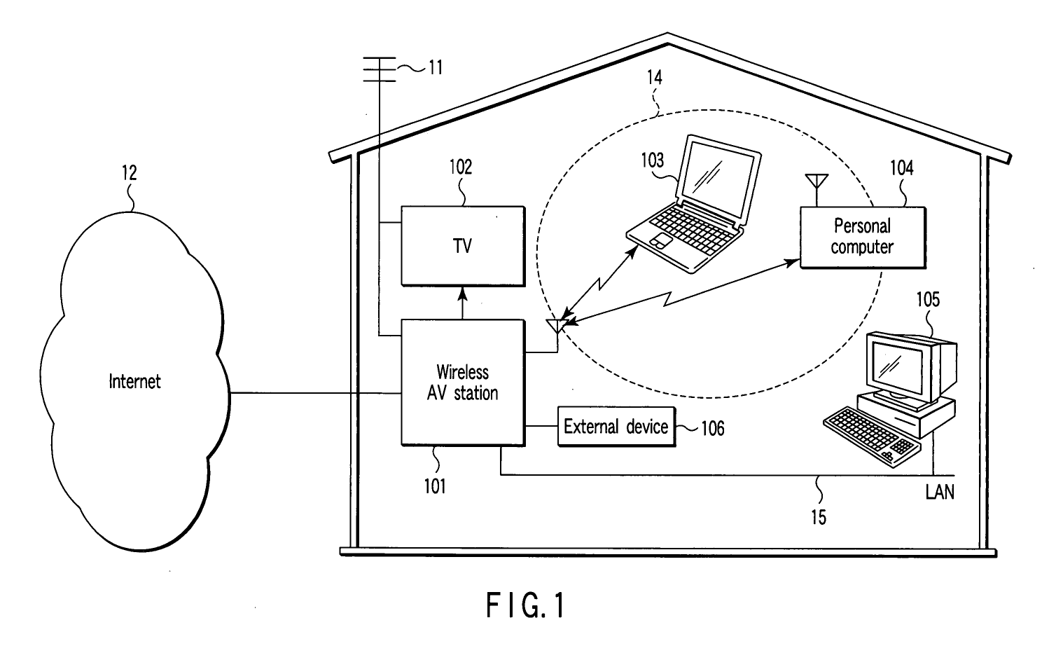

FIG. 1 shows the configuration of a home network system using a data transmission apparatus according to the embodiment of the present invention. The home network system includes a wireless Audio-Video (AV) station 101, a TV receiver 102, notebook personal computers 103 and 104, and a desktop personal computer 105.

The wireless AV station 101 is a data transmission apparatus functioning as a home server. The wireless AV station 101 offers services, such as viewing/listening of broadcast data of, e.g. TV programs, viewing/listening of content data that is input from an external device and Internet browsing, to the information processing terminals such as personal computers 103 to 105 over a household wireless or wired local network.

The wireless AV station 101 is connected to an external global network (external network) such as the Internet 12 via a communication line. The communication line is, for example, an ISDN (Integrated Services Digital Network), an ADSL (Asymmetric Digital Subscriber Line) or a CATV (Cable TV). Further, the wireless AV station 101 is connected to the respective household information processing terminals over the household wireless or wired network.

Each of the personal computers 103 to 105 is a information processing terminal functioning as a client of the wireless AV station 101. Each of the notebook personal computers 103 and 104 is equipped with a wireless communication device. Thereby, each of the notebook personal computers 103 and 104 can be connected to the wireless AV station 101 via a wireless communication network (wireless LAN) 14. In addition, the desktop personal computer 105 is connected to the wireless AV station 101 via a wired communication network (wired LAN) 15.

The wireless AV station 101 connects each of the personal computers 103 to 105 to the Internet 12, and executes data transmission between a Web site on the Internet 12 and each of the personal computers 103 to 105.

An antenna cable connected to an outdoor TV broadcast receiving antenna 11 is led into the house. The TV receiver 102 and wireless AV station 101 are connected to the antenna cable. Broadcast data sent from a broadcast station can be received and reproduced by the TV receiver 102 and can also be received by the wireless AV station 101. The wireless AV station 101 transmits the received broadcast data to the personal computer 103, 104, 105 via the household wireless or wired local network. In addition, the wireless AV station 101 can output the received broadcast data to the TV receiver 102.

The wireless AV station 101 is also connected to an external device 106 such as a video player, a camera or an audio player. The wireless AV station 101 can receive content data such as video data, still-image data or music data from the external device 106. The wireless AV station 101 transmits the received content data to each of the personal computers 103, 104, 105 via the household wireless or wired local network. In addition, the wireless AV station 101 can output the received content data to the TV receiver 102.

Main functions that are provided by the wireless AV station 101 are as follows.

Router Function

The router function is a function for connecting the household wireless local network 14 or wired local network 15 and the Internet 12. Using the router function, each of the personal computers 103 to 105 can communicate with a Web site on the Internet 12 and can communicate with some other personal computer on the local network.

TV Function

The TV function is a function for receiving broadcast program data in response to a request from each of the personal computers 103 to 105, which is connected to the household wireless or wired local network 14, 15. The wireless AV station 101 can transmit the received broadcast program data to the requesting personal computer, or output the received broadcast program data to the TV 102. The wireless AV station 101 includes a plurality of broadcast program data receiving units so that a plurality of information processing terminals can use the TV function at the same time.

TV Recording Function

The wireless AV station 101 includes a magnetic disk drive unit (hard disk drive [HDD]) as a large-capacity storage device for recording broadcast program data. The wireless AV station 101, for example, can record currently broadcast program data in the magnetic disk drive unit as a file, while transmitting the broadcast program data to the information processing terminal. In addition, the wireless AV station 101 can receive other currently broadcast program data and record it in the magnetic disk drive unit, while transmitting the broadcast program data already stored in the magnetic disk drive unit to the information processing terminal. Furthermore, the wireless AV station 101 can output the broadcast program data stored in the magnetic disk drive unit to the TV receiver 102.

External Input Function

The external input function is a function for receiving (inputting) content data from the external device 106 in response to a request from each of the personal computers 103 to 105, that is connected to the household wireless or wired local network 14, 15. The wireless AV station 101 can transmit the content data received from the external device 106 to the requesting personal computer, or can output the received content data to the TV 102. In addition, the wireless AV station 101 can record the content data received from the external device 106 in the magnetic disk drive unit as a file.

Content Server Function

In response to a data acquisition request from each of the personal computers 103 to 105, the wireless AV station 101 can transmit to the requesting personal computer the broadcast program data and content data, which are recorded in the magnetic disk drive unit as files.

Remote Control Function

The TV function, TV recording function, external input function and content server function of the wireless AV station 101 can be remote-controlled from each of the personal computers 103 to 105. In addition, a dedicated remote control unit for operating the wireless AV station 101 may be used to control the TV function, TV recording function, external input function and content server function of the wireless AV station 101.

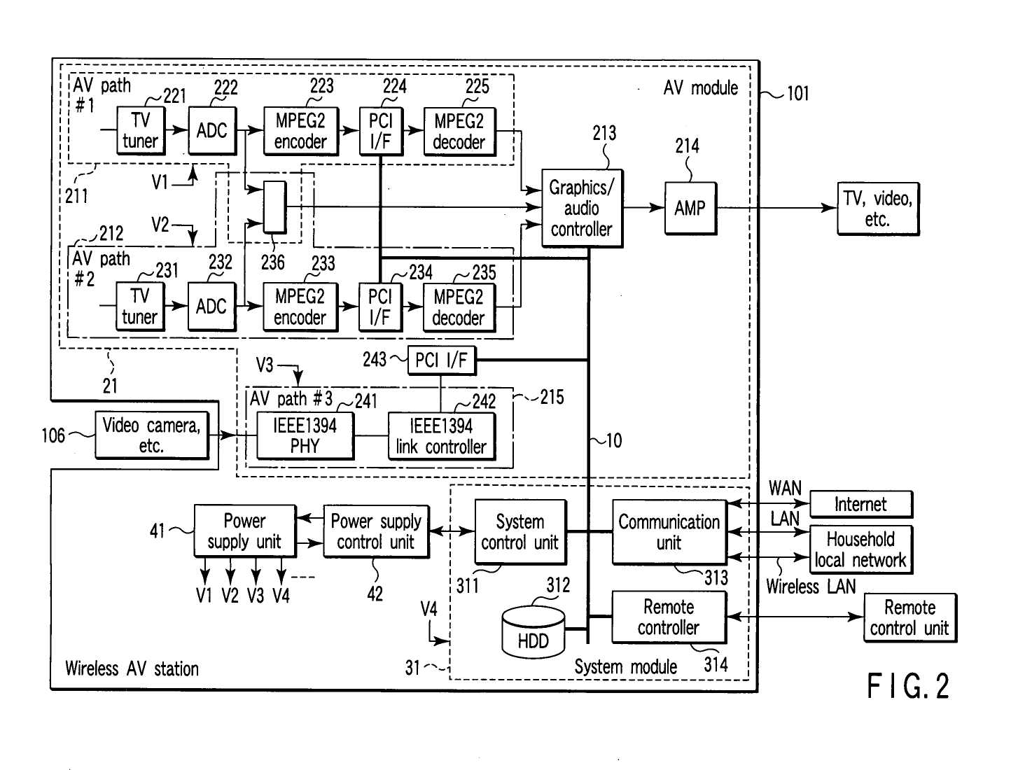

Next, referring to FIG. 2, the system configuration of the wireless AV station 101 is described.

The wireless AV station 101, as shown in FIG. 2, includes an AV (Audio-Video) module 21, a system module 31, a power supply unit 41 and a power supply control unit 42. The AV module 21 executes the above-described TV function, TV recording function and external input function. The AV module 21 includes a first AV path 211, a second AV path 212, a graphics/audio controller 213 and an amplifier (AMP) 214. The AV module 21 is connected to the system module 31 via a bus 10 such as a PCI (Peripheral Component Interconnect) bus.

The first and second AV paths 211 and 212 are receiving units for receiving broadcast program data, which is requested from each information processing terminal. The first and second AV paths 211 and 212 are driven by mutually independent powers V1 and V2. The powers V1 and V2 are power supply voltages supplied from the power supply unit 41, and are supplied to the first and second AV paths 211 and 212 as operational powers. The two AV paths 211 and 212 can offer the TV function or the TV recording function to two information processing terminals at the same time.

Further, the AV module 21 includes a third AV path 215. The third AV path 215 is a unit for receiving content data, such as AV data, from the external device 106 in response to a request from the information processing terminal. The third AV path 215 is driven by a power V3. The power V3 is a power supply voltage supplied from the power supply unit 41, and is supplied to the third AV path 215 as an operational power.

The graphics/audio controller 213 is an output device for outputting broadcast program data and content data to the external TV receiver 102 or AV equipment. The graphics/audio controller 213 outputs to the external TV receiver 102 or AV equipment the broadcast program data that is received by the AV path 211 or 212, the content data that is received by the AV path 215 from the external device 106, or the data that is stored in an HDD 312 of the system module 31.

The first AV path 211 includes a TV tuner 221, an analog-to-digital converter (ADC) 222, an MPEG2 (MPEG: Moving Picture Coding Experts Group/Moving Picture Experts Group) encoder 223, a PCI bus interface (PCI I/F) 224, and an MPEG2 decoder 225. The tuner 221 is connected to the TV antenna 11. The tuner 221 is a device that receives broadcast program data on a channel, listening/viewing of which is requested from the personal computer 103, 104, 105 or a remote control unit. Based on a TV reception request (request for TV listening/viewing), the TV tuner 221 receives TV broadcast signals and selects the channel. The analog-to-digital converter (ADC) 222, MPEG2 encoder 223, PCI bus interface (PCI I/F) 224 and MPEG2 decoder 225 constitute a broadcast data processing unit that processes the TV broadcast program data that is received by the TV tuner 221. TV broadcast program data on a certain channel, which is received by the TV tuner 221, is sent to the analog-to-digital converter (ADC) 222 and converted from an analog signal to a digital signal.

In the case where the TV broadcast program data that is received by the TV tuner 221 is output to the TV receiver 102, the converted TV broadcast data in digital signal form is sent to the graphics/audio controller 213 via a selector 236. On the other hand, in the case where the TV broadcast program data that is received by the TV tuner 221 is sent to the requesting information processing terminal or recorded in the HDD 312 in the system module 31, the converted TV broadcast data in digital signal form is delivered to the MPEG2 encoder 223. The MPEG2 encoder 223 compression-encodes the TV broadcast program data. The compression-encoded TV broadcast program data is delivered to the system module 31 via the PCI bus interface (PCI I/F) 224 and bus 10. In the case of recording the TV broadcast program data, which is received by the TV tuner 221, in the HDD 312 in the system module 31 while outputting it to the TV receiver 102, the TV broadcast program data that is converted to the digital signal by the analog-to-digital converter (ADC) 222 is supplied to both the selector 236 and MPEG2 encoder 223.

The MPEG2 decoder 225 decodes the compression-encoded TV broadcast program data. The MPEG2 decoder 225 is used in the case of outputting the compression-encoded TV broadcast program data, which is recorded in the HDD 312 in the system module 31, to the TV receiver 102. In this manner, the first AV path 211 executes the reception process for broadcast data and the broadcast data process for recording and reproducing the received broadcast data.

The second AV path 212, like the first AV path 211, includes a TV tuner 231, an analog-to-digital converter (ADC) 232, an MPEG2 encoder 233, a PCI bus interface (PCI I/F) 234, and an MPEG2 decoder 235. The tuner 231 is a device that receives broadcast program data on a channel, listening/viewing of which is requested from the personal computer 103, 104, 105 or the remote control unit. Based on the TV reception request (request for TV listening/viewing), the TV tuner 231 effects reception of TV broadcast signals and selection of the channel. The analog-to-digital converter (ADC) 232, MPEG2 encoder 233, PCI bus interface (PCI I/F) 234 and MPEG2 decoder 235 constitute a broadcast data processing unit that processes the TV broadcast program data that is received by the TV tuner 231. TV broadcast program data on a certain channel, which is received by the TV tuner 231, is sent to the analog-to-digital converter (ADC) 232 and converted from an analog signal to a digital signal.

In the case where the TV broadcast program data that is received by the TV tuner 231 is output to the TV receiver 102, the converted TV broadcast data in digital signal form is sent to the graphics/audio controller 213 via the selector 236. On the other hand, in the case where the TV broadcast program data that is received by the TV tuner 231 is sent to the requesting information processing terminal or recorded in the HDD 312 in the system module 31, the converted TV broadcast data in digital signal form is delivered to the MPEG2 encoder 233. The MPEG2 encoder 233 compression-encodes the TV broadcast program data. The compression-encoded TV broadcast program data is delivered to the system module 31 via the PCI bus interface (PCI I/F) 234 and bus 10. In the case of recording the TV broadcast program data, which is received by the TV tuner 231, in the HDD 312 in the system module 31 while outputting it to the TV receiver 102, the TV broadcast program data that is converted to the digital signal by the analog-to-digital converter (ADC) 232 is supplied to both the selector 236 and MPEG2 encoder 233.

The MPEG2 decoder 235 decodes the compression-encoded TV broadcast program data. The MPEG2 decoder 235 is used in the case of outputting the compression-encoded TV broadcast program data, which is recorded in the HDD 312 in the system module 31, to the TV receiver 102. In this manner, the second AV path 212 executes the reception process for broadcast data and the broadcast data process for recording and reproducing the received broadcast data.

The third AV path 215 is an I/O interface that executes communication with an external device that supports, e.g. the IEEE 1394 serial interface standard. The third AV path 215, as shown in FIG. 2, comprises a physical controller (IEEE 1394 PHY) 241 and a link controller (IEEE 1394 Link) 242. The third AV path 215 is connected to the bus 10 via a PCI bus interface (PCI I/F) 243. The external device 106 is realized, for instance, as an IEEE 1394 device. In the case where content data that is input from the external device 106 is output to the TV receiver 102, the content data that is received from the external device 106 by the third AV path 215 is sent to the graphics/audio controller 213 via the bus 10. On the other hand, in the case where content data that is input from the external device 106 is delivered to the requesting information processing terminal, or content data that is input from the external device 106 is recorded in the HDD 312 in the system module 31, the content data that is received from the external device 106 by the third AV path 215 is sent to the system module 31 via the bus 10.

The system module 31 includes a system control unit 311, HDD 312, a communication unit 313 and a remote controller 314. The system control unit 311, HDD 312, communication unit 313 and remote controller 314 are driven by a power V4 that is supplied from the power supply unit 41. The power V4 is a power supply voltage, and is supplied to the system module 31 as operational power. The system control unit 311 is a processor that controls the operation of the wireless AV station 101. The system control unit 311 controls the operation of the AV module 21 in accordance with a TV/content data viewing/listening request, which is received via the remote controller 314 from the remote control unit, and a TV/content data viewing/listening request, which is received from each of personal computers 103 to 105, via the communication unit 313. The system control unit 311 has a monitor function for monitoring the states of use of the AV paths 211, 212 and 215, and a power supply control function for individually controlling power-on/off of the AV path 211, the power-on/off of the AV path 212 and the power-on/off of the AV path 215 through the power supply control unit 42 so as to turn off the power to the AV path that is not currently used.

The communication unit 313 is a device for executing the above-mentioned router function. The communication unit 313 executes data transmission between a household local network (wireless LAN 14, wired LAN 15) and the Internet 12. The communication unit 313 includes an IP masquerade function, a NAT (Network Address Translation) function and a DHCP (Dynamic Host Configuration Protocol) function. The communication unit 313 includes a WAN (Wide Area Network) terminal for connection to the Internet 12, a wireless communication device for execution of communication with the wireless LAN 14, and a LAN (Local Area Network) terminal for connection to the wired LAN 15. The communication unit 313 executes data communication between the personal computers 103 to 105 over the household local network (wireless LAN 14, wired LAN 15) and data communication between each of the personal computers 103 to 105 and the Internet 12. The communication unit 313 is connected to the system control unit 311 via the bus 10. If the communication unit 313 receives a TV/content data viewing/listening request from any one of the personal computers 103 to 105, the communication unit 313 transmits the received TV/content data viewing/listening request to the system control unit 311. In addition, the communication unit 313 has a function of transmitting, under control of the system control unit 311, the TV broadcast program data/content data, which is received by the AV module 21, to the personal computers 103 to 105 via the local network.

The remote controller 314 executes communication with the remote control unit. A TV viewing/listening request sent from the remote control unit is received by the remote controller 314 and delivered to the system control unit 311 via the bus 10.

The power supply unit 41 is a power supply device that supplies powers to the respective modules, which constitute the wireless AV station 101. The power supply unit 41 independently controls the supply of power V1 to the AV path 211, the supply of power V2 to the AV path 212, the supply of power V3 to the AV path 215 and the supply of power V4 to the system module 31 in accordance with a power supply control signal from the power supply control unit 42. The power supply control unit 42 delivers a power supply control signal to the power supply unit 41 in accordance with a request from the system control unit 311. In addition, the power supply control unit 42 monitors the operation of the power supply unit 41 by means of a power supply status signal from the power supply unit 41, thereby to detect occurrence of abnormality in power supply.

In the wireless AV station 101, the supply of power V4 to the communication unit 313, which functions as the router, and the supply of powers V1, V2 and V3 to the first to third AV paths 211, 212 and 215 can be independently controlled. If the content server function and Web browsing function are used and the TV function, TV recording function and external input function are not used, the supply of powers V1, V2 and V3 to the first to third AV paths 211, 212 and 215 can be stopped while power V4 is being supplied to the communication unit 313. Furthermore, in the wireless AV station 101, it is possible to independently control the supply of power V1 to the AV path 211, the supply of power V2 to the AV path 212 and the supply of power V3 to the AV path 215. On the basis of the states of use of the first to third AV paths 211, 212 and 215, the power-on/off of the first AV path 211, second AV path 212 and third AV path 215 can be individually controlled and power can be supplied to only the AV path that requires power supply. For example, in the case where only one terminal uses the TV function/TV recording function, power is supplied to only one of the first and second AV paths 211 and 212. If two terminals simultaneously use the TV function/TV recording function, power is supplied to both the first and second AV paths 211 and 212. If the TV function and TV recording function are not used and the external input function is used, no power is supplied to the first AV path 211 or second AV path 212, and power is supplied to the third AV path 215 alone.

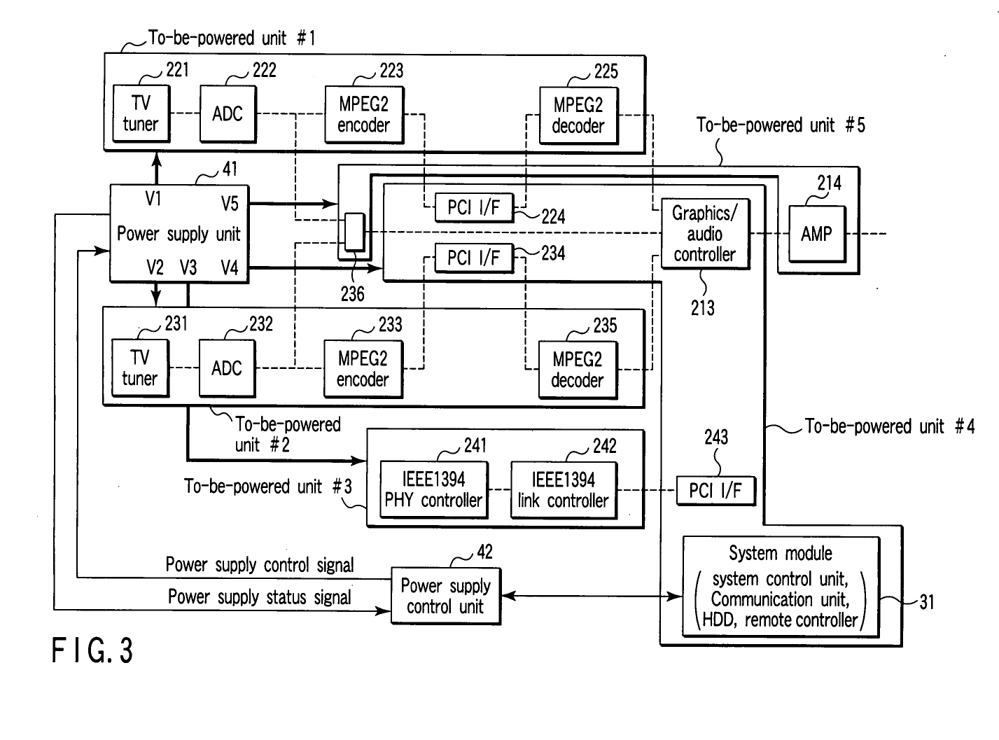

Next, referring to FIG. 3, a specific power supply system that is provided in the wireless AV station 101 is described.

The components of the wireless AV station 101 are classified into first to fifth to-be-powered units (five in total). The TV tuner 221, analog-to-digital converter (ADC) 222, MPEG2 encoder 223 and MPEG2 decoder 225 in the first AV path 211 belong to the first to-be-powered unit. The power V1 is supplied as operational power to these components. The TV tuner 231, analog-to-digital converter (ADC) 232, MPEG2 encoder 233 and MPEG2 decoder 235 in the second AV path 212 belong to the second to-be-powered unit. The power V2 is supplied as operational power to these components. The physical controller (IEEE 1394 PHY) 241 and link controller (IEEE 1394 Link) 242 in the third AV path 215 belong to the third to-be-powered unit. The power V3 is supplied as operational power to these components.

The components directly connected to the bus 10, that is, the system module 31 (system control unit 311, HDD 312, communication unit 313 and remote controller 314), graphics/audio controller 213 and PCI bus interfaces (PCI I/F) 224, 234 and 243, belong to the fourth to-be-powered unit. The power V4 is supplied as operational power to these components. The components that are used to output broadcast program data/content data to the TV 102, that is, the selector 236 and amplifier (AMP) 214, belong to the fifth to-be-powered unit. The power V5 is supplied as operational power to these components.

The power supply unit 41 can independently control the supply of powers V1, V2, V3, V4 and V5. The power supply unit 41 includes five power output sections corresponding to the powers V1, V2, V3, V4 and V5. For example, in accordance with a power supply control signal from the power supply control unit 42, switch circuits provided in the five power output sections are selectively on/off controlled, thereby individually on/off controlling the powers V1, V2, V3, V4 and V5. While the wireless AV station 101 is being turned on, the power V4 is always supplied to the fourth to-be-powered unit. The powers V1, V2, V3 and V5 are turned on/off, where necessary.

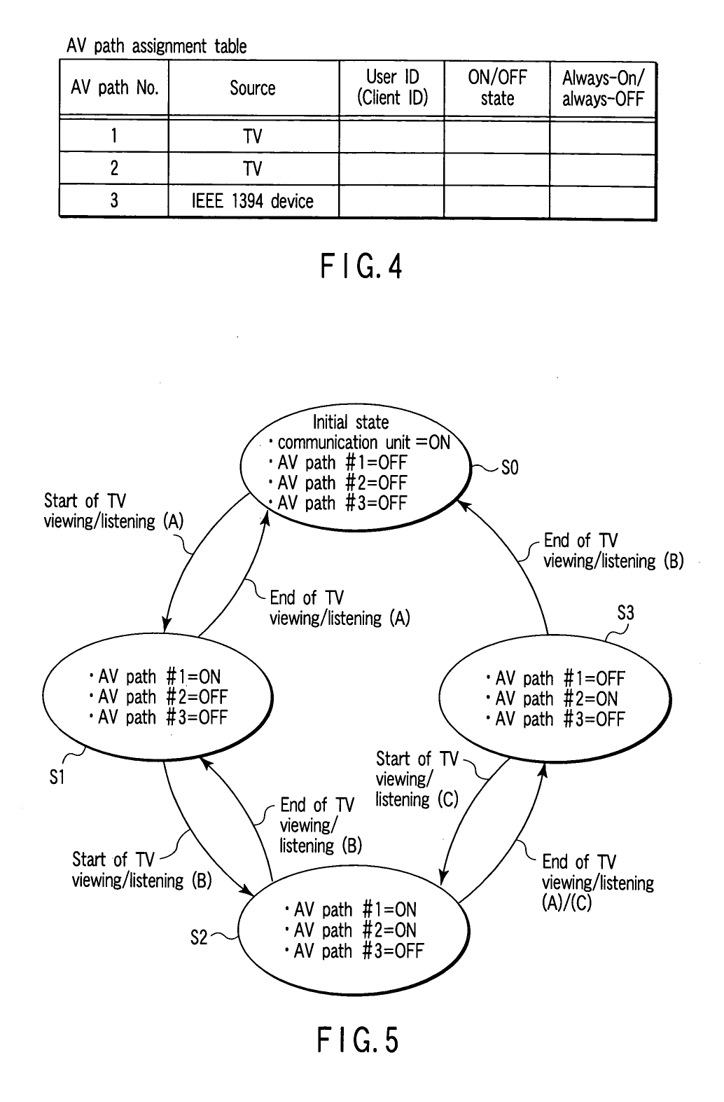

FIG. 4 shows an example of an AV path assignment table, which the system control unit 311 uses in order to manage the states of use of the AV paths 211, 212 and 215. The AV path assignment table stores information representative of “SOURCE”, “USER ID”, “ON/OFF STATE” and “ALWAYS-ON/ALWAYS-OFF” in connection with each of the AV path numbers. Item “SOURCE” indicates the kind of source data (TV, IEEE 1394 device) corresponding to the associated AV path. Item “USER ID” indicates an ID (client ID) that identifies the terminal using the associated AV path. For instance, the device ID, which is assigned to each of the personal computers 103 to 105 and remote control unit, is used as the client ID. Item “ON/OFF STATE” indicates whether the associated AV path is currently in use, that is, whether the current power supply state is ON or OFF. Item “ALWAYS-ON/ALWAYS-OFF” is setting information that is used when the associated AV path is set in an always-on state or an always-off state.

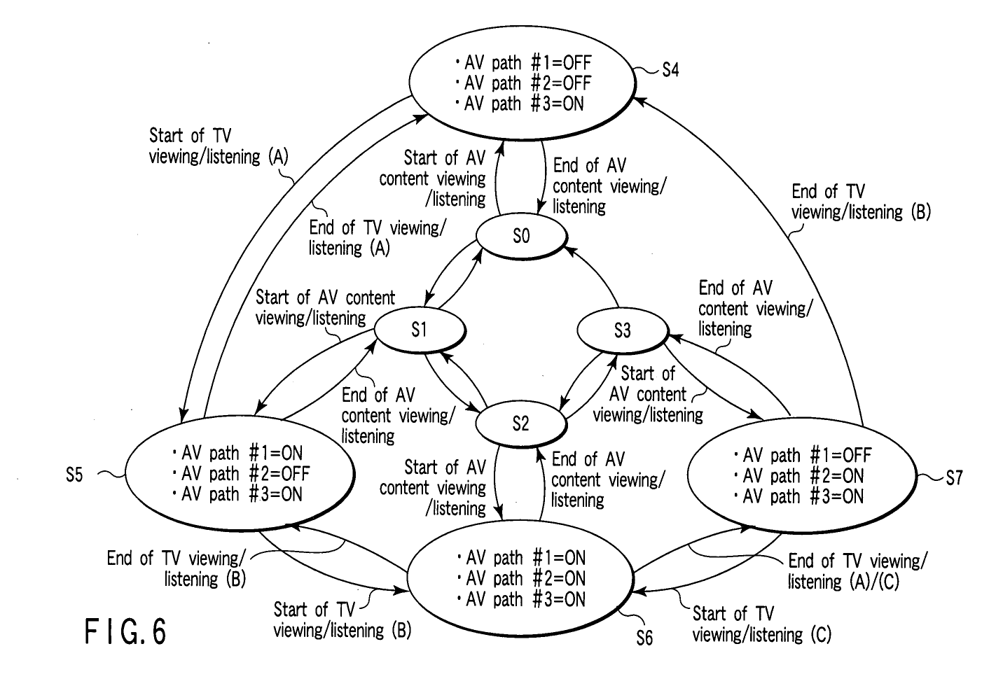

Next, referring to FIG. 5 and FIG. 6, a description is given of how the power supply state transits in the communication unit 313, first AV path 211, second AV path 212 and third AV path 215.

FIG. 5 illustrates a transition of the power-supply states of the first AV path 211, second AV path 212 and third AV path 215 in accordance with the states of use of the first and second AV paths 211 and 212 for TV viewing/listening. If the wireless AV station 101 is powered on, the power supply state of the wireless AV station 101 is set in state S0 (initial state). In the state S0, power V4 is supplied to the communication unit 313. However, powers V1, V2 and V3 are not supplied to the associated first AV path 211, second AV path 212 and third AV path 215. Specifically, when power to the wireless AV station 101 is turned on, only the power V4 is supplied to the to-be-powered unit 4 in the state in which the power to the first AV path 211, second AV path 212 and third AV path 215 is turned off. When the wireless AV station 101 functions only as the router or when the wireless AV station 101 functions to transmit the broadcast program data/content data, which is recorded in the HDD 312, to the information processing terminal via the communication unit 313, the AV module 21 is not used. Thus, the wireless AV station 101 is maintained in the state S0.

If the communication unit 313 receives, in the state S0, a TV viewing/listening request (A) from a certain terminal (e.g. ID=A) over the local network, the power supply state transits to a state S1 (first AV path=ON, second AV path=OFF, third AV path=OFF). In the state S, although power is supplied to the first AV path 211, no power is supplied to the second AV path 212 or third AV path 215. Power is supplied to the communication unit 313. Specifically, when the TV viewing/listening request (A) is received, a currently non-used first AV path 211 is assigned to the terminal (ID=A), which has sent the TV viewing/listening request (A), as the receiving device for receiving broadcast program data designated by the terminal (ID=A) that has sent the TV viewing/listening request (A). Then, supply of power V1 is started to the first to-be-powered unit that corresponds to the first AV path 211 assigned to the terminal (ID=A). Thereby, the first AV path 211 is powered on. The broadcast program data that is received by the AV path 211 is sent to the terminal (ID=A) via the communication unit 313 or output to the TV 102. When the broadcast program data is output to the TV 102, the supply of power V5 to the to-be-powered unit 5 is also started and the selector 236 and amplifier 214 are powered on. Whether the broadcast program data is to be output to the terminal (ID=A) or to the TV 102 is designated by the TV viewing/listening request (A). If the TV viewing/listening request (A) calls for recording, the broadcast program data that is received by the AV path 211 is recorded in the HDD 312.

If the terminal (ID=A) transmits a TV viewing/listening end request in the state S1, the AV path 211 that is assigned to the terminal (ID=A) is powered off and the power supply state is returned to the state S0. On the other hand, if the communication unit 313 receives, in the state S, a TV viewing/listening request (B) from another terminal (e.g. ID=B) over the local network, the power supply state transits from the state S1 to a state S2 (first AV path=ON, second AV path=ON, third AV path=OFF). Specifically, when the TV viewing/listening request (B) is received, a currently non-used second AV path 212 is selected and assigned to the terminal (ID=B) as the receiving device for receiving broadcast program data designated by the terminal (ID=B) that has sent the TV viewing/listening request (B). Then, supply of power V2 is started to the second to-be-powered unit that corresponds to the second AV path 212. Thereby, the second AV path 212 is powered on. The power-on state of the first AV path 211 is maintained and also the power-on state of the communication unit 313 is maintained. The power-off state of the third AV path 215 is maintained. The broadcast program data that is received by the second AV path 212 is sent to the terminal (ID=B) via the communication unit 313 or output to the TV 102. If the TV 102 is already used by the TV viewing/listening request (A), the broadcast program data that is received by the AV path 212 cannot be output to the TV 102. If the TV viewing/listening request (B) calls for recording, the broadcast program data that is received by the AV path 212 is recorded in the HDD 312.

If the terminal (ID=B) transmits a TV viewing/listening end request in the state S2, the second AV path 212 that is assigned to the terminal (ID=B) is powered off and the power supply state is returned to the state S1.

On the other hand, if the terminal (ID=A) transmits a TV viewing/listening end request in the state S2, the first AV path 211 that is assigned to the terminal (ID=A) is powered off and the power supply state transits to a state S3 (first AV path=OFF, second AV path=ON, third AV path=OFF). If the terminal (ID=B) transmits a TV viewing/listening end request in the state S3, the second AV path 212 that is assigned to the terminal (ID=B) is powered off and the power supply state transits to the state S0.

If the communication unit 313 receives, in the state S3, a TV viewing/listening request (C) from some other terminal (e.g. ID=C) over the local network, the power supply state transits from the state S3 to the state S2. In the state S2, in order to receive broadcast program data that is designated by the TV viewing/listening request (C), a currently non-used first AV path 211 is assigned to the terminal (ID=C). Then, supply of power V1 is started to the to-be-powered unit 1 that corresponds to the first AV path 211, and the AV path 211 is powered on.

FIG. 6 illustrates a transition of the power-supply states of the first AV path 211, second AV path 212 and third AV path 215 in a case where consideration is also given to a change in the state of use of the third AV path 215 for viewing/listening content data from the external device 106.

In the state S0, if a certain terminal transmits a content data viewing/listening request (AV content viewing/listening request), the power supply state transits from the state S0 to a state S4 (first AV path=OFF, second AV path=OFF, third AV path=ON). Specifically, when the AV content viewing/listening request is transmitted from a certain terminal, the third AV path 215 is assigned to the terminal that has sent the AV content viewing/listening request. Then, supply of power V3 is started to the third to-be-powered unit that corresponds to the third AV path 215. Thereby, the third AV path 215 is powered on. The content data that is received from the external device 106 by the third AV path 215 is sent via the communication unit 313 to the terminal that has transmitted the AV content viewing/listening request or is output to the TV 102. When the content data is output to the TV 102, the supply of power V5 to the fifth to-be-powered unit is also started and the selector 236 and amplifier 214 are powered on. Whether the content data is to be output to the terminal or to the TV 102 is designated by the AV content viewing/listening request. If the AV content viewing/listening request calls for recording, the content data that is received from the external device 106 by the third AV path 215 is recorded in the HDD 312. If the terminal, to which the third AV path 215 is assigned, transmits an AV content viewing/listening end request in the state S4, the power supply state is returned to the state S0.

If a certain terminal transmits an AV content viewing/listening request in the state S1, the third AV path 215 is assigned to the terminal that has sent the AV content viewing/listening request and the power supply state transits from the state S1 to a state S5 (first AV path=ON, second AV path=OFF, third AV path=ON). If the terminal, to which the third AV path 215 is assigned, transmits an AV content viewing/listening end request in the state S5, the power supply state is returned to the state S1.

If a certain terminal transmits an AV content viewing/listening request in the state S2, the third AV path 215 is assigned to the terminal that has sent the AV content viewing/listening request and the power supply state transits from the state S2 to a state S6 (first AV path=ON, second AV path=ON, third AV path=ON). If the terminal, to which the third AV path 215 is assigned, transmits an AV content viewing/listening end request in the state S6, the power supply state is returned to the state S2.

If a certain terminal transmits an AV content viewing/listening request in the state S3, the third AV path 215 is assigned to the terminal that has sent the AV content viewing/listening request and the power supply state transits from the state S3 to a state S7 (first AV path=OFF, second AV path=ON, third AV path=ON). If the terminal, to which the third AV path 215 is assigned, transmits an AV content viewing/listening end request in the state S7, the power supply state is returned to the state S3.

The transitions between the states S4, S5, S6 and S7 are executed under the same conditions as those between the states S0, S1, S2 and S3, which have been described with reference to FIG. 5.

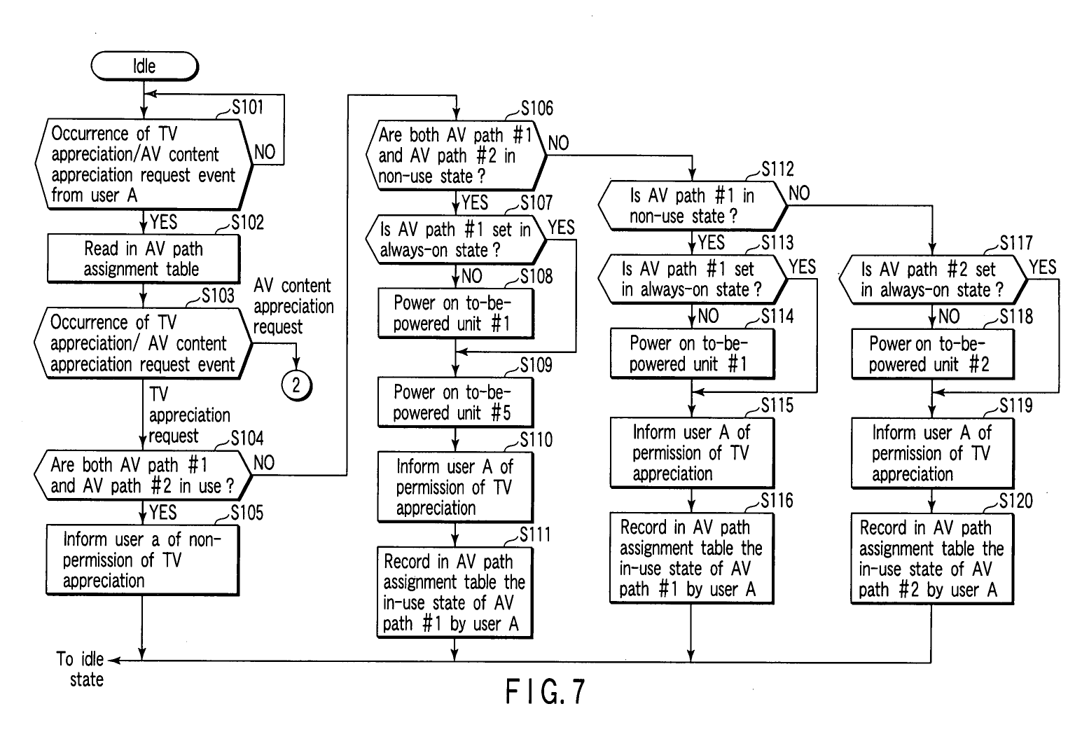

Next, referring to a flowchart of FIG. 7, a description is given of the power-on sequence control process that is executed by the system control unit 311 in order to individually power on the first AV path 211, second AV path 212 and third AV path 215.

If the communication unit 313 receives a viewing/listening (appreciation) request from a certain terminal (e.g. ID=A) (YES in step S101), the system control unit 311 refers to the AV path assignment stable shown in FIG. 4 and checks the current states of use of the AV paths 211, 212 and 215 (step S102). Then, the system control unit 311 determines whether the received viewing/listening request is a TV viewing/listening request or an AV content viewing/listening request (step S103). If the received viewing/listening request is the TV viewing/listening request, the following process is executed.

The system control unit 311 determines whether both the first and second AV paths 211 and 212 are currently in use (step S104). If both the first and second AV paths 211 and 212 are currently used (YES in step S104), the system control unit 311 sends a message indicative of non-permission of TV viewing/listening to the terminal (ID=A), which has sent the TV viewing/listening request, through communication between the terminal (ID=A) that has sent the TV viewing/listening request and the communication unit 313 (step S105).

On the other hand, if both the first and second AV paths 211 and 212 are in the non-use state (YES in step S106), the system control unit 311 assigns the first AV path 211 to the terminal (ID=A) as the AV path that is to be used for reception of broadcast program data designated by the terminal (ID=A). In this case, the system control unit 311 determines whether the first AV path 211 is set in the always-on state (step S107). If the first AV path 211 is not set in the always-on state (NO in step S107), the system control unit 311 controls the power supply unit 41 through the power supply control unit 42 so as to supply power to the first to-be-powered unit that corresponds to the first AV path 211 (step S108). Then, the system control unit 311 controls the power supply unit 41 through the power supply control unit 42 so as to supply power to the fifth to-be-powered unit (step S109).

The system control unit 311 sends a message indicative of permission of TV viewing/listening to the terminal (ID=A), which has sent the TV viewing/listening request, through communication between the terminal (ID=A) that has sent the TV viewing/listening request and the communication unit 313 (step S110). Then, the system control unit 311 records, in the AV path assignment table, information indicative of the current use of the first AV path 211 by the terminal (ID=A) (step S111). In step S111, ID=A is registered in the [USER ID] field corresponding to the first AV path 211, and information indicative of on-state is registered in the [ON/OFF STATE] field corresponding to the first AV path 211.

If the first AV path 211 is in the non-use state and the second AV path 212 is in use (YES in step S112), the system control unit 311 assigns the first AV path 211 to the terminal (ID=A) as the AV path that is to be used for reception of broadcast program data designated by the terminal (ID=A). In this case, the system control unit 311 determines whether the first AV path 211 is set in the always-on state (step S113). If the first AV path 211 is not set in the always-on state (NO in step S113), the system control unit 311 controls the power supply unit 41 through the power supply control unit 42 so as to supply power to the first to-be-powered unit that corresponds to the first AV path 211 (step S114). Then, the system control unit 311 sends a message indicative of permission of TV viewing/listening to the terminal (ID=A), which has sent the TV viewing/listening request, through communication between the terminal (ID=A) that has sent the TV viewing/listening request and the communication unit 313 (step S115). Thereafter, the system control unit 311 records, in the AV path assignment table, information indicative of the current use of the first AV path 211 by the terminal (ID=A) (step S116). In step S116, ID=A is registered in the [USER ID] field corresponding to the first AV path 211, and information indicative of on-state is registered in the [ON/OFF STATE] field corresponding to the first AV path 211.

If the first AV path 211 is in use and the second AV path 212 is not in use (NO in step S112), the system control unit 311 assigns the second AV path 212 to the terminal (ID=A) as the AV path that is to be used for reception of broadcast program data designated by the terminal (ID=A). In this case, the system control unit 311 determines whether the second AV path 212 is set in the always-on state (step S117). If the second AV path 211 is not set in the always-on state (NO in step S117), the system control unit 311 controls the power supply unit 41 through the power supply control unit 42 so as to supply power to the second to-be-powered unit that corresponds to the second AV path 212 (step S118). Then, the system control unit 311 sends a message indicative of permission of TV viewing/listening to the terminal (ID=A), which has sent the TV viewing/listening request, through communication between the terminal (ID=A) that has sent the TV viewing/listening request and the communication unit 313 (step S119). Thereafter, the system control unit 311 records, in the AV path assignment table, information indicative of the current use of the second AV path 212 by the terminal (ID=A) (step S120). In step S120, ID=A is registered in the [USER ID] field corresponding to the second AV path 212, and information indicative of on-state is registered in the [ON/OFF STATE] field corresponding to the second AV path 212.

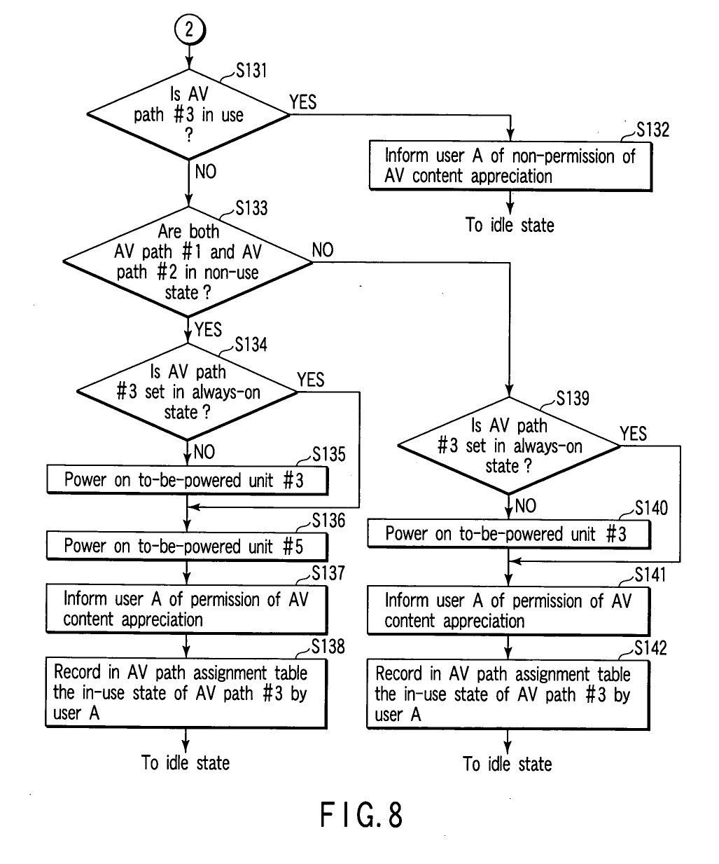

In step S103, if the received viewing/listening request is the AV content viewing/listening request, a procedure illustrated in FIG. 8 is executed as described below.

The system control unit 311 determines whether the third AV path 215 is currently in use (step S131). If the third AV path 215 is currently used (YES in step S131), the system control unit 311 sends a message indicative of non-permission of AV content viewing/listening to the terminal (ID=A), which has sent the AV content viewing/listening request, through communication between the terminal (ID=A) that has sent the AV content viewing/listening request and the communication unit 313 (step S132).

If the third AV path 215 is not in use (NO in step S131), the system control unit 311 determines whether both the first and second AV paths 211 and 212 are in the non-use state (step S133).

If both the first and second AV paths 211 and 212 are in the non-use state (YES in step S133), the system control unit 311 assigns the third AV path 215 to the terminal (ID=A) that has sent the AV content viewing/listening request. In this case, the system control unit 311 determines whether the third AV path 215 is set in the always-on state (step S134). If the third AV path 215 is not set in the always-on state (NO in step S134), the system control unit 311 controls the power supply unit 41 through the power supply control unit 42 so as to supply power to the third to-be-powered unit that corresponds to the third AV path 215 (step S135). Then, the system control unit 311 controls the power supply unit 41 through the power supply control unit 42 so as to supply power to the fifth to-be-powered unit (step S136).

The system control unit 311 sends a message indicative of permission of AV content viewing/listening to the terminal (ID=A), which has sent the AV content viewing/listening request, through communication between the terminal (ID=A) that has sent the AV content viewing/listening request and the communication unit 313 (step S137). Then, the system control unit 311 records, in the AV path assignment table, information indicative of the current use of the third AV path 215 by the terminal (ID=A) (step S138). In step S138, ID=A is registered in the [USER ID] field corresponding to the third AV path 215, and information indicative of on-state is registered in the [ON/OFF STATE] field corresponding to the third AV path 215.

If at least one of the first and second AV paths 211 and 212 is currently in use (NO in step S133), the following process is executed.

The system control unit 311 assigns the third AV path 215 to the terminal (ID=A) that has sent the AV content viewing/listening request. In this case, the system control unit 311 determines whether the third AV path 215 is set in the always-on state (step S139). If the third AV path 215 is not set in the always-on state (NO in step S139), the system control unit 311 controls the power supply unit 41 through the power supply control unit 42 so as to supply power to the third to-be-powered unit that corresponds to the third AV path 215 (step S140). Then, the system control unit 311 sends a message indicative of permission of AV content viewing/listening to the terminal (ID=A), which has sent the AV content viewing/listening request, through communication between the terminal (ID=A) that has sent the AV content viewing/listening request and the communication unit 313 (step S141). Thereafter, the system control unit 311 records, in the AV path assignment table, information indicative of the current use of the third AV path 215 by the terminal (ID=A) (step S142). In step S142, ID=A is registered in the [USER ID] field corresponding to the third AV path 215, and information indicative of on-state is registered in the [ON/OFF STATE] field corresponding to the third AV path 215.

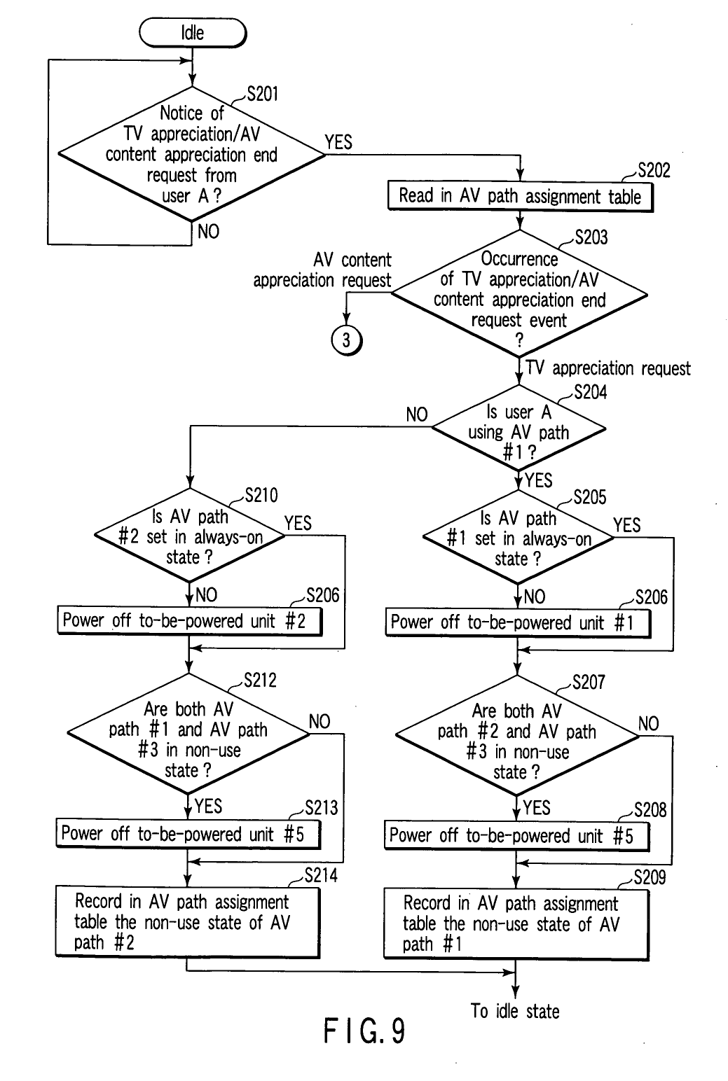

Next, referring to a flowchart of FIG. 9, a description is given of the power-off sequence control process that is executed by the system control unit 311 in order to individually power off the first AV path 211, second AV path 212 and third AV path 215.

If the communication unit 313 receives a viewing/listening end request from a certain terminal (e.g. ID=A) (YES in step S201), the system control unit 311 reads in the AV path assignment stable (step S202). Then, the system control unit 311 determines whether the received viewing/listening end request is a TV viewing/listening end request or an AV content viewing/listening end request (step S203). If the received viewing/listening end request is the TV viewing/listening end request, the following process is executed.

The system control unit 311 determines, looking up the AV path assignment table, whether the AV path that is assigned to and used by the terminal (ID=A), which has sent the TV viewing/listening end request, is the first AV path 211 or the second AV path 212 (step S204). If the AV path that is used by the terminal (ID=A), which has sent the TV viewing/listening end request, is the first AV path 211 (YES in step S204), the system control unit 311 determines whether the first AV path 211 is set in the always-on state (step S205). If the first AV path 211 is not set in the always-on state (NO in step S205), the system control unit 311 controls the power supply unit 41 through the power supply control unit 42 so as to stop the supply of power to the first to-be-powered unit that corresponds to the first AV path 211 (step S206). Then, the system control unit 311 determines, referring to the AV path assignment table, whether both the second AV path 212 and third AV path 213 are in the non-use state (step S207). If both the second AV path 212 and third AV path 213 are in the non-use state, power supply to the fifth to-be-powered unit is needless. Thus, the system control unit 311 controls the power supply unit 41 through the power supply control unit 42 so as to stop the supply of power to the fifth to-be-powered unit (step S208). Then, the system control unit 311 records, in the AV path assignment table, information indicative of the non-use state of the first AV path 211 (step S209). In step S209, the registered content in the [USER ID] field corresponding to the first AV path 211 is cleared, and information indicative of off-state is registered in the [ON/OFF STATE] field corresponding to the first AV path 211.

If the AV path that is used by the terminal (ID=A), which has sent the TV viewing/listening end request, is the second AV path 212 (NO in step S204), the system control unit 311 determines whether the second AV path 212 is set in the always-on state (step S210). If the second AV path 212 is not set in the always-on state (NO in step S210), the system control unit 311 controls the power supply unit 41 through the power supply control unit 42 so as to stop the supply of power to the second to-be-powered unit that corresponds to the second AV path 212 (step S211). Then, the system control unit 311 determines, referring to the AV path assignment table, whether both the first AV path 211 and third AV path 213 are in the non-use state (step S212). If both the first AV path 211 and third AV path 215 are in the non-use state, power supply to the fifth to-be-powered unit is needless. Thus, the system control unit 311 controls the power supply unit 41 through the power supply control unit 42 so as to stop the supply of power to the fifth to-be-powered unit (step S213). Then, the system control unit 311 records, in the AV path assignment table, information indicative of the non-use state of the second AV path 212 (step S214). In step S214, the registered content in the [USER ID] field corresponding to the second AV path 212 is cleared, and information indicative of off-state is registered in the [ON/OFF STATE] field corresponding to the second AV path 212.

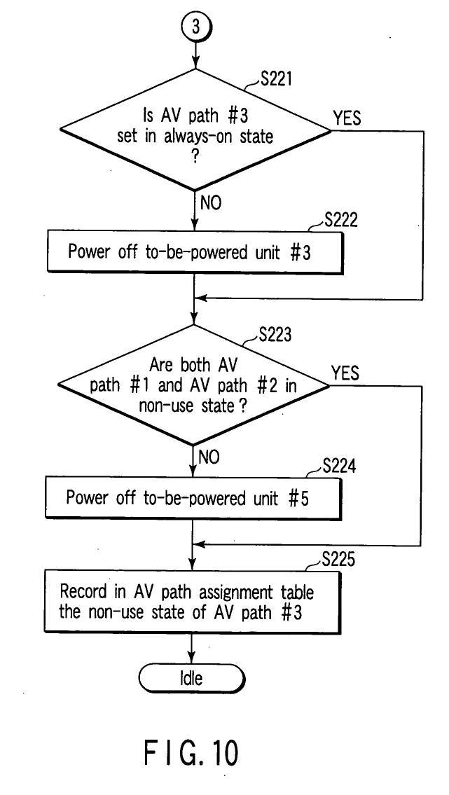

In step S203, if it is determined that the received viewing/listening end request is the AV content viewing/listening end request, a procedure illustrated in FIG. 10 is executed in the following manner.

The system control unit 311 determines whether the third AV path 215 is set in the always-on state (step S221). If the third AV path 215 is not set in the always-on state (NO in step S221), the system control unit 311 controls the power supply unit 41 through the power supply control unit 42 so as to stop the supply of power to the third to-be-powered unit that corresponds to the third AV path 215 (step S222). Then, the system control unit 311 determines, referring to the AV path assignment table, whether both the first AV path 211 and second AV path 212 are in the non-use state (step S223). If both the first AV path 211 and second AV path 212 are in the non-use state, power supply to the fifth to-be-powered unit is needless. Thus, the system control unit 311 controls the power supply unit 41 through the power supply control unit 42 so as to stop the supply of power to the fifth to-be-powered unit (step S224). Then, the system control unit 311 records, in the AV path assignment table, information indicative of the non-use state of the third AV path 215 (step S225). In step S225, the registered content in the [USER ID] field corresponding to the third AV path 215 is cleared, and information indicative of off-state is registered in the [ON/OFF STATE] field corresponding to the third AV path 215.

As has been described above, according to the present embodiment, the power supply to the communication unit 313 and the power supply to each of the first to third AV paths 211, 212 and 215 can independently be controlled. When neither the broadcast program receiving service nor the content data receiving service from the external device 106 is used, for example, in such a case that the wireless AV station 101 functions only as the router or the broadcast program data/content data recorded in the HDD 312 is being sent to the information processing terminal via the communication unit 313, it is possible to stop power supply to each of the first to third AV paths 211, 212 and 215. Moreover, since the first to third AV paths 211, 212 and 215 can individually be powered on/off in accordance with the states of use of the AV paths 211, 212 and 215, power can be supplied to only the AV path that requires power supply. Without causing wasteful power consumption, the communication service, broadcast program receiving service and content data receiving service from the external device can be offered to a plurality of terminals 103 to 105. In particular, as regards the AV paths 211 and 212, the power supply to the entire AV path, which includes not only the TV tuner but also the broadcast data processing unit for processing broadcast data received by the TV tuner, is turned off until the AV path is assigned to the terminal that sends a broadcast data reception request. Therefore, compared to the case of turning off the power supply to only the TV tuner, further power saving can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A data transmission apparatus for receiving data in accordance with a request from each of a plurality of terminals, the apparatus being connected to an external device, comprising:
a power supply unit that outputs a first power, a second power and a third power;
a communication unit that is driven by the first power and executes data transmission between an external network and a local network to which said plurality of terminals are connected;
a first receiving unit that is driven by the second power and receives broadcast data in response to a broadcast data reception request from each of the terminals, the broadcast data reception request being received by the communication unit;
a second receiving unit that is driven by the third power and receives content data from the external device in response to a content data reception request from each of the terminals, the content data reception request being received by the communication unit; and
a power supply control unit configured to control the power supply unit based on states of use of the first receiving unit and the second receiving unit to individually power on/off the first receiving unit and the second receiving unit while the communication unit is powered on.

2. The data transmission apparatus according to claim 1, wherein the power supply control unit includes:
means for determining whether a reception request, which is transmitted from any one of the plurality of terminals to the communication unit, is said broadcast data reception request or said content data reception request;
means for controlling the power supply unit and powering on the first receiving unit if the reception request is the broadcast data reception request, and for controlling the power supply unit and powering on the second receiving unit if the reception request is the content data reception request;
means for determining whether a reception end request, which is transmitted from any one of the plurality of terminals to the communication unit, is a broadcast data reception end request or a content data reception end request; and
means for controlling the power supply unit and powering off the first receiving unit if the reception end request is the broadcast data reception end request, and for controlling the power supply unit and powering off the second receiving unit if the reception end request is the content data reception end request.

3. The data transmission apparatus according to claim 1, wherein the communication unit is configured to transmit the broadcast data, which is received by the first receiving unit, via the local network to the terminal that transmits the broadcast data reception request.

4. The data transmission apparatus according to claim 1, wherein the communication unit is configured to transmit the content data, which is received by the second receiving unit, via the local network to the terminal that transmits the content data reception request.

5. The data transmission apparatus according to claim 1, further comprising an output device configured to output the broadcast data, which is received by the first receiving unit, to external video equipment.

6. The data transmission apparatus according to claim 1, further comprising an output device configured to output the content data, which is received by the second receiving unit, to external video equipment.

7. The data transmission apparatus according to claim 1, further comprising:
a data storage device; and
means for storing the broadcast data, which is received by the first receiving unit, in the data storage device.

8. The data transmission apparatus according to claim 1, further comprising:
a data storage device; and
means for storing the content data, which is received by the second receiving unit, in the data storage device.

9. A data transmission apparatus for receiving data in accordance with a request from each of a plurality of terminals, the apparatus being connected to an external device, comprising:
a communication unit that is driven by a first power and executes data transmission between an external network and a local network to which said plurality of terminals are connected;
a first receiving unit that is driven by a second power and receives broadcast data;
a second receiving unit that is driven by a third power and receives broadcast data;
a third receiving unit that is driven by a fourth power and receives content data from the external device;
a power supply unit that outputs the first power, the second power, the third power and the fourth power;
means for, when the communication unit receives a broadcast data reception request, selectively assigning one of the first receiving unit and the second receiving unit to one of the plurality of terminals, which transmits the broadcast data reception request, to enable said one of the first receiving unit and the second receiving unit to receive broadcast data that is designated by the one of the plurality of terminals which transmits the broadcast data reception request;
means for, when the communication unit receives a content data reception request, assigning the third receiving unit to one of the plurality of terminals, which transmits the content data reception request, to enable the third receiving unit to receive content data that is designated by the one of the plurality of terminals which transmits the content data reception request; and
a power supply control unit configured to control the power supply unit based on states of use of the first receiving unit, the second receiving unit and the third receiving unit to individually power on/off the first receiving unit, the second receiving unit and the third receiving unit while the communication unit is powered on.

10. The data transmission apparatus according to claim 9, wherein the power supply control unit includes:
means for controlling the power supply unit and powering on one of the first receiving unit and the second receiving unit, which is assigned to the terminal that transmits the broadcast data reception request;
means for, when the communication unit receives a broadcast data reception end request, determining which of the first receiving unit and the second receiving unit is assigned to one of the plurality of terminals, which transmits the broadcast data reception end request, based on information indicative of a relationship between a terminal that transmits the broadcast data reception request and the receiving unit that is assigned to the terminal; and
means for powering off one of the first receiving unit and the second receiving unit, which is determined to be assigned to said one of the plurality of terminals that transmits the broadcast data reception end request.

11. A method of controlling a power supply to a data transmission apparatus that includes a first receiving unit which receives broadcast data, a second receiving unit which receives content data from an external device, and a communication unit that executes data transmission between an external network and a local network to which a plurality of terminals are connected, the method comprising:
powering on the communication unit while the first receiving unit and the second receiving unit are kept in a power-off state;
determining whether a reception request, which is transmitted from any one of the plurality of terminals to the communication unit, is a broadcast data reception request or a content data reception request;
powering on the first receiving unit if the reception request is the broadcast data reception request, and powering on the second receiving unit if the reception request is the content data reception request;
determining whether a reception end request, which is transmitted from any one of the plurality of terminals to the communication unit, is a broadcast data reception end request or a content data reception end request; and
powering off the first receiving unit if the reception end request is the broadcast data reception end request, and powering off the second receiving unit if the reception end request is the content data reception end request.

12. The method according to claim 11, further comprising:
transmitting broadcast data, which is received by the first receiving unit, via the local network to the terminal that transmits the broadcast data reception request.

13. The method according to claim 11, further comprising:
transmitting content data, which is received by the second receiving unit, via the local network to the terminal that transmits the content data reception request.
